(19) United States
(12) Patent Application Publication
(10) Pub. No.: US 2013/0118297 A1
(43) Pub. Date: May 16, 2013

(54) ANTI-THEFT STEERING WHEEL

(71) Applicants: Seng Kiat GOH, Selangor (MY); Seng Toh GOH, Selangor (MY)

(72) Inventors: Seng Kiat GOH, Selangor (MY); Seng Toh GOH, Selangor (MY)

(73) Assignees: SENG TOH GOH, SELANGOR (MY); SENG KIAT GOH, SELANGOR (MY)

(21) Appl. No.: 13/296,633

(22) Filed: Nov. 15, 2011

(51) Int. Cl. B62D 1/10

(52) U.S. Cl. 74/552

(57) ABSTRACT

A steering wheel that can be quickly assembled and disassembled includes a fixed unit and a connecting unit, and a first interval is formed at a bottom portion of the fixed unit. Several ball slots are formed outside the connecting portion, and several fixed connecting points are formed at the end of the connecting portion. The connecting unit has a top portion and a conjugating portion, wherein the conjugating portion has several rolling balls and movable connecting points, and the connecting unit covers the connecting portion of the fixed unit through the conjugating portion. The rolling balls and ball slots are used to form a structure for quickly assembling and disassembling the steering wheel, and when the rolling balls are not aligned with the ball slots, the fixed connecting points and movable connecting points have an appropriate space in between to avoid a short circuit.

### FIELD OF THE INVENTION

The present invention relates to a steering wheel assembling and disassembling device, and particularly to an anti-theft steering wheel that can be quickly assembled and disassembled and avoid a short circuit during assembly and disassembly process.

### BACKGROUND OF THE INVENTION

The increase of vehicle theft rate does not go down with the invention of various anti-theft devices. From the locking devices at earlier time to the modern anti-theft locks, vehicle theft cases never stop to occur. Currently, the vehicle anti-theft devices can be divided into mechanical, electrical and GPS devices according to its structure. We often see the mechanical anti-theft devices such as crutch locks, steering wheel locks, gear locks and wheel locks. These mechanical locks are to lock clutch, brake, throttle, steering wheel, gear lever and the wheel to prevent the vehicle from being stolen. Electrical anti-theft devices are the most widely used ones, including card-insertion style, keypad style and remote control style. The electrical anti-theft devices are operated mainly through the transmission and encoding/decoding to control the opening and closing the door or engine ignition by computer, or by the built-in lock to cut off the oil or the power to achieve the purpose of anti-theft. Meanwhile, they have the feature of audible alarm. However, it is disadvantageous that the electrical devices may be decoded or cracked easily. As to GPS anti-theft device, although GPS devices cannot prevent vehicles from being stolen, they can quickly determine the position of the stolen vehicle to find the vehicle, as well as the thief's location. So, GPS devices are the most effective anti-theft devices so far. However, they have the drawbacks of high price and loss communication at some specific locations. Therefore, someone suggests that the steering wheel can be removed to prevent vehicle theft, so the thief may have spend more time to prepare and assemble a steering wheel if he/she wants to steal the vehicle, and the thief may end up not stealing the vehicle without a steering wheel to avoid troubles. This method to prevent vehicle theft receives better anti-theft results with lower costs. However, it may be disadvantageous that since most steering wheels in modern vehicles are equipped with a plurality of electronic control devices to control speaker, turn light, volume, call forwarding, etc., the electronic connections may be short due to wrongful connections when the steering wheel is assembled or disassembled, and the electronic devices may be therefore damaged.

### SUMMARY OF THE INVENTION

The present invention provides a steering wheel that can be quickly assembled or disassembled to sole the problems stated above. The steering wheel includes a fixed unit and a connecting unit, and the fixed unit has a bottom portion and a connecting portion. The bottom portion of the fixed unit is used to connect the steering wheel stick of the vehicle, and a first interval is formed at the bottom portion. A plurality of ball slots are formed outside the connecting portion, and a plurality of fixed connecting points are formed at the end of the connecting portion. The connecting unit has a top portion and a conjugating portion, and the top portion of the connecting unit is used to connect the steering wheel of the vehicle. The conjugating portion has a plurality of rolling balls and movable connecting points, and the end of the conjugating portion has a second interval. The connecting unit covers the connecting portion of the fixed unit through the conjugating portion, and the rolling balls and ball slots are used to form a structure for quickly assembling and disassembling the steering wheel.

The main object of the present invention is that the fixed unit has a plurality of ball slots while the connecting unit has a plurality of rolling balls, and the rolling balls and the ball slots form a structure to quickly assemble and disassemble the fixed unit and the connecting unit. The fixed unit has a first interval at the bottom portion, and the second interval is formed at the conjugating portion of the connecting unit. When the rolling balls does not align with the ball slot, the movable connecting points and the fixed connecting points has an appropriate space using the first interval and second interval to avoid a short circuit due to incorrect connection and to assure the safety when assembling and disassembling the steering wheel.

The second object of the present invention is that the connecting unit has an auxiliary cover outside the control cover, and the auxiliary cover has an extended wing portion to provide a large surface area for the user to hold to further facilitate the assembling and disassembling process of the connecting unit.

### BRIEF DESCRIPTION OF THE DRAWINGS

FIG. 1 illustrates a three-dimensional view in the present invention.

FIG. 2 illustrates an exploded view in the present invention.

FIG. 3 illustrates a disassembled view of the fixed unit and connecting unit in the present invention.

FIG. 4 illustrates a sectional view of the fixed unit and connecting unit in the present invention.

FIG. 5 illustrates a sectional view of the fixed unit and connecting unit when not aligned in the present invention.

FIG. 6 illustrates a sectional view of the fixed unit and connecting unit when aligned in the present invention.

FIG. 7 illustrates a sectional view of another embodiment in the present invention when in use.

FIG. 8 illustrates a sectional view of an auxiliary cover in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

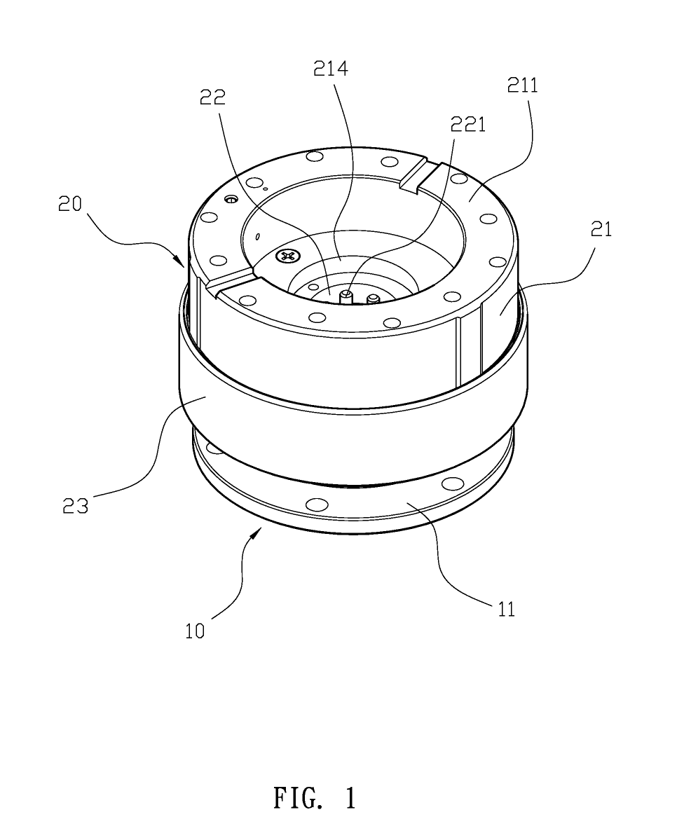

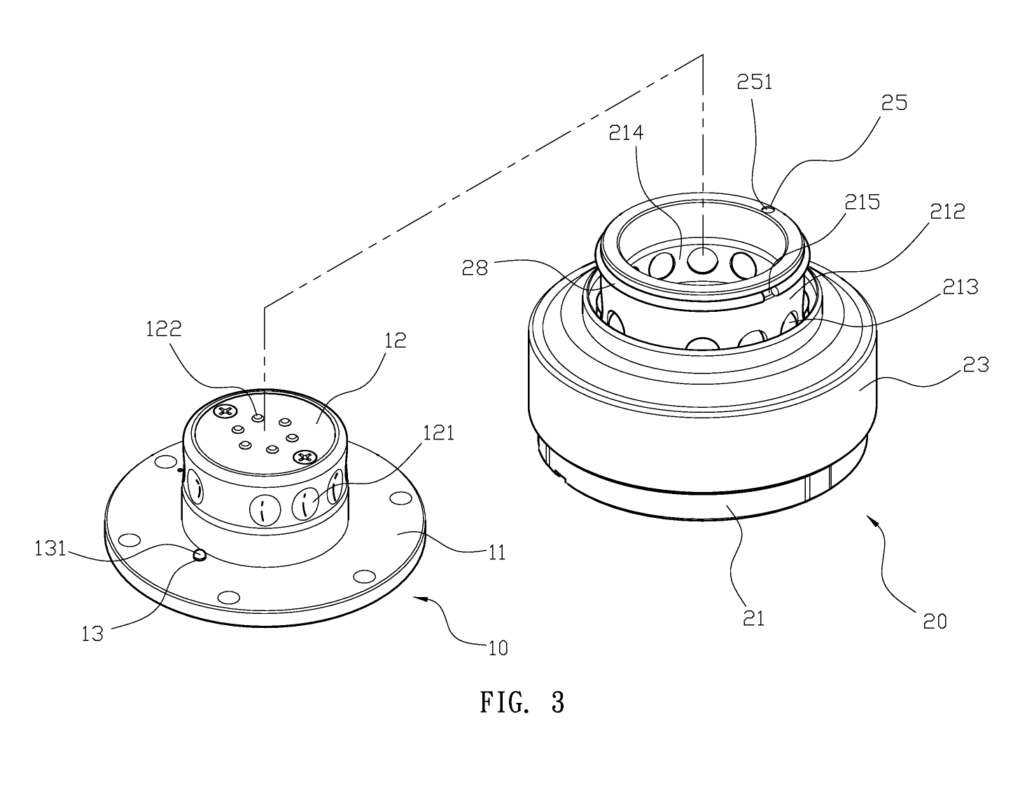

Referring to FIGS. 1, 2 and 3, an anti-theft steering wheel that can be quickly disassembled includes a fixed unit (10) and a connecting unit (20). The fixed unit (10) and the connecting unit (20) can be assembled and disassembled quickly, so that a steering wheel and steering wheel stick can be disassembled quickly through the fixed unit (10) and the connecting unit (20), to achieve the goal of anti-theft by removing the steering wheel, wherein the fixed unit has a bottom portion (11) and a connecting portion (12), and the bottom portion (11) of the fixed unit (10) is used to connect the steering wheel stick of the vehicle, and the bottom portion (11) forms a first interval (13) having a protruding block (131). The connecting portion (12) has a plurality of ball slots (121) at an outer periphery, and a plurality of fixed connecting points (122) are formed at the end of the connecting portion (12). The connecting unit (20) has a top portion (211) and a conjugating portion (212), and the top portion (211) of the connecting unit (20) is used to connect the steering wheel of the vehicle. A plurality of rolling balls (213) and movable connecting points (221) are protrudingly formed at the conjugating portion (212). Each fixed connecting point (122) of the fixed unit (10) and each movable connecting point (221) of the connecting unit (20) includes an anode connecting point and a cathode connecting point, and the cathode connecting point can be connected with a plurality of anode connecting point. A second interval (25) is formed at the end of the conjugating portion (212) and a recessed slot (251) is formed at the second interval (25) to receive the protruding block (131) so that the connecting unit (20) and the fixed unit (10) can stay contact with each other, as well as the fixed connecting points (122) and the movable connecting points (221). The connecting unit (20) also has a main connecting body (21), a connecting plate (22), a control cover (23) and a spring (24). The top portion (211) and the conjugating portion (212) are formed at the main connecting body (21), and the movable connecting point (221) is formed at the connecting plate (22) that is secured by a screw inside the main connecting body (21). A through hole (214) is formed inside the main connecting body (21) through the top portion (211) and conjugating portion (212), and the connecting plate (22) is located in the through hole (214). A ring (26) and a resilient unit (27) are formed between the connecting plate (22) and main connecting body (21), so that the ring (26) can push against the rolling ball (213) of the conjugating portion (212) under normal situation using the force provided by the resilient unit (27). Also, the control cover (23) covers the conjugating portion (212) of the connecting unit (20), and the control cover (23) recessedly forms an escaping ring slot (231) towards the conjugating portion (212) to provide a space for the rolling balls (213). The spring (24) is disposed between the control cover (23) and main connecting body (21), and when the control cover (23) moves relatively to the main connecting body (21) to compresses the spring (24), the rolling balls (213) can roll into the escaping ring slot (231) of the control cover (23). A ring slot (215) is formed at the conjugating portion (212) of the connecting unit (20) and the ring slot (215) has a C-shaped hook (28) to stop the control cover (23), so that the control cover (23) and spring (24) cannot escape from the main connecting body (21). Based on the structure mentioned above, the connecting unit (20) covers the connecting portion (12) of the fixed unit (10) through the conjugating portion (212), and using the rolling balls (213) and ball slots (121) to form a structure that can be quickly disassembled. When the rolling balls (213) and the ball slots (121) are not aligned, the fixed connecting points (122) and movable connecting points (221) has an appropriate space using misalignment of the first interval (13) and second interval (25) to avoid a short circuit due to incorrect connection, and further assure the safety when disassembling the steering wheel.

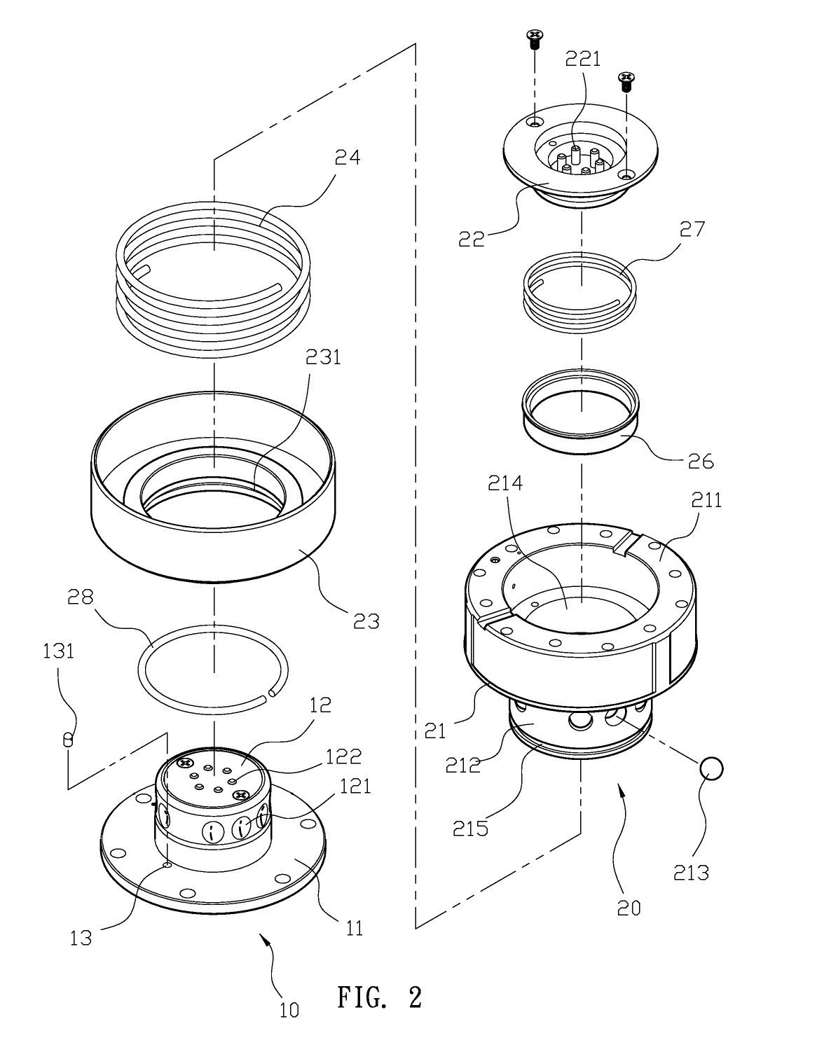

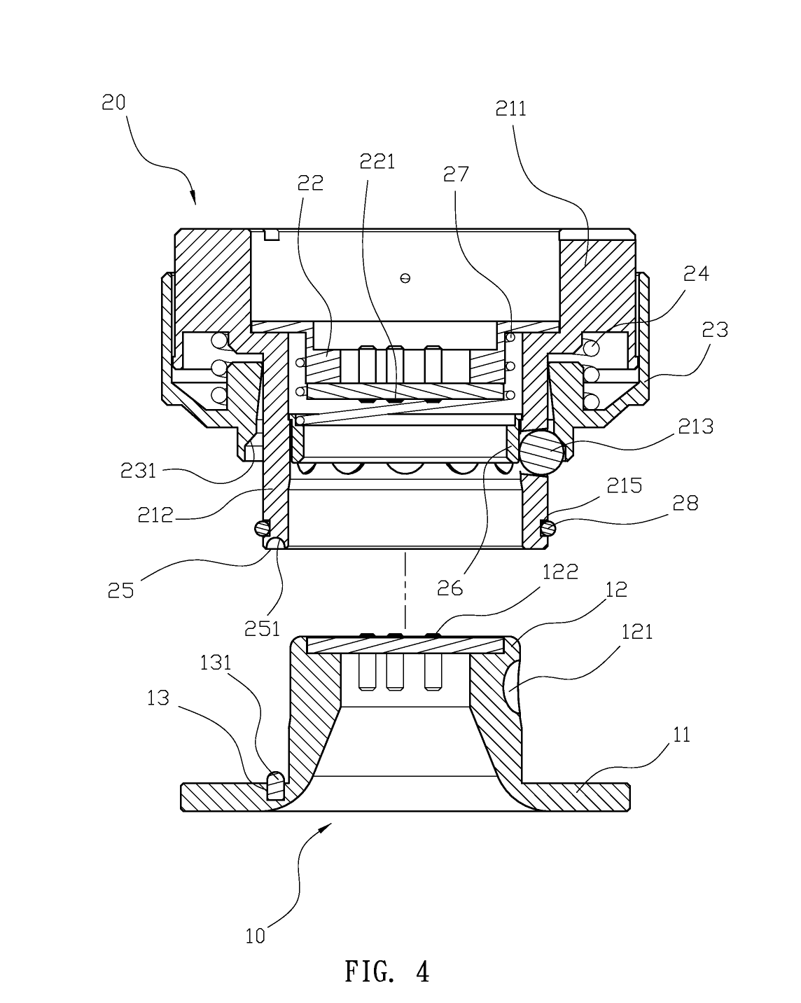

Referring to FIGS. 2, 3 and 4, the connecting unit (20) orderly disposes the ring (26) and resilient unit (27) into the through hole (214) of the main connecting body (21), and the connecting plate (22) is locked inside the main connecting body (21), so that the resilient unit (27) is compressed by the connecting plate (22) and the ring (26) to push the ring (26) towards the direction of the rolling balls (213) of the conjugating portion (212). Also, the main connecting body (21) has the spring (24) disposed outside the conjugating portion (212) and has the control cover (23) to compress the spring with the main connecting body (21). Furthermore, the C-shaped hook (28) is at the ring slot (215) of the conjugating portion (212), so that the control cover (23) and spring cannot escape from the main connecting body (21) to complete the assembly process. The connecting unit (20) covers the connecting portion (12) of the fixed unit (10) through the conjugating portion (212), and when the rolling balls (213) align with the ball slots (121) of the fixed unit (10), the rolling balls (213) roll into the ball slots (121), so that the control cover (23) can be pushed by the spring (24) to cover the conjugating portion (212). At this time, the rolling balls (213) are stopped by the control cover (23) and can only stay in the ball slots (121) to achieve the goal of quickly assembling and disassembling the connecting unit (20) and fixed unit (10).

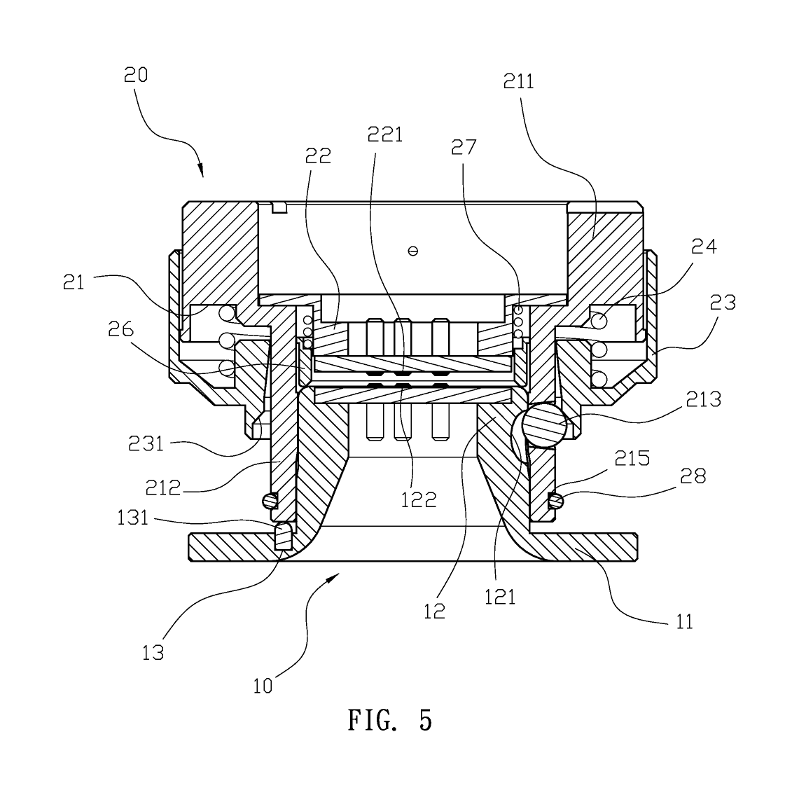

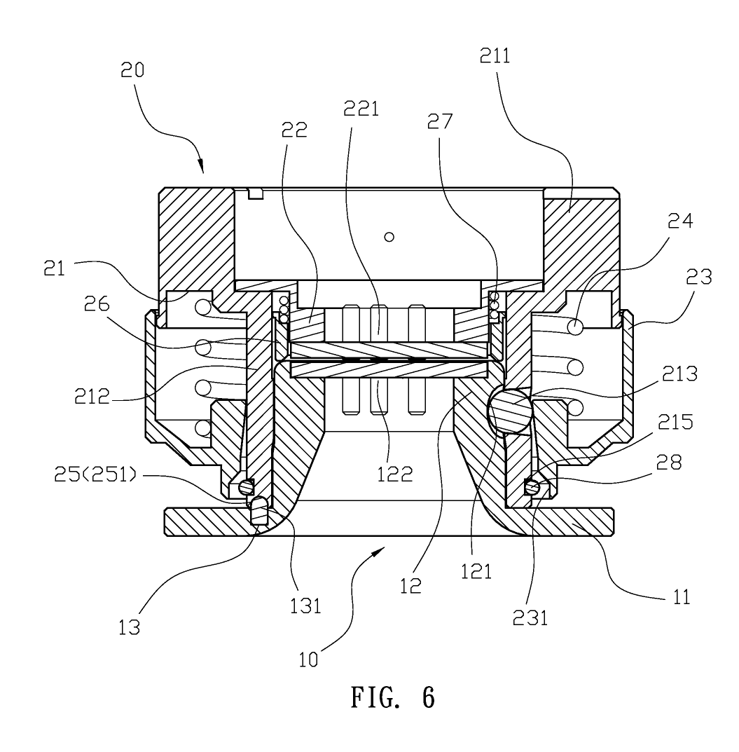

Referring to FIGS. 2 to 6, the present invention is a steering wheel that can be disassembled quickly when in use to achieve the goal of anti-theft. The fixed unit (10) is secured at the steering wheel stick of the vehicle through the bottom portion (11) and the connecting unit (20) is disposed at the steering wheel at the top portion (211). When the fixed unit (10) and the connecting unit (20) are separated, the control cover (23) compresses the spring (24) towards the direction of the top portion (211), so that the rolling balls (213) in the conjugating portion (212) of the main connecting body (21) goes out to locate in the escaping ring slot (231), and the ring (26) in the main connecting body (21) is simultaneously pushed by the resilient unit (27) to block the rolling balls (213) on its inner lateral surface to form a secured situation when separated. When the steering wheel is to dispose on the steering wheel stick, the conjugating portion (212) of the connecting unit (12) covers the conjugating portion (12) of the fixed unit (10) to rotate the main connecting body (21) to adjust the angle between the rolling balls (213) and the ball slots (121). At this time, the first interval (13) of the fixed unit (10) has a protruding block (131) disposed in the conjugating portion (212) of the connecting unit (20), so that the rolling balls (213) of the connecting unit (20) cannot further move close to the fixed unit (10) before aligning with the ball slots (121) to form an appropriate space between the movable connecting points (221) of the connecting unit (20) and the fixed connecting points (122) of the fixed unit (10) to avoid a short circuit due to incorrect connection. When the rolling balls (213) align with the ball slots (121), the rolling balls (213) roll into the ball slots (121), so the control cover (23) moves towards the fixed unit (10) and further blocks the rolling balls (213) to form a connecting status between the connecting unit (20) and the fixed unit (10). On the contrary, the user can press the control cover (23) by hands to align the escaping ring slot (231) with the rolling balls (213) and ball slots (121). In other words, the escaping ring slot (231) can provide a space for the rolling balls (231) to escape from the ball slots (121) to achieve the goal of quickly assembling and disassembling the fixed unit (10) and the connecting unit (20).

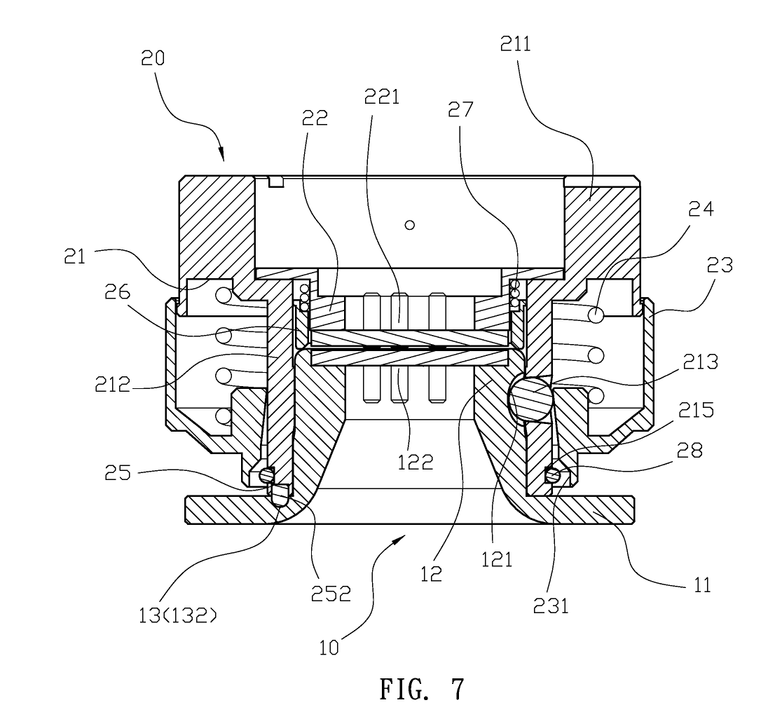

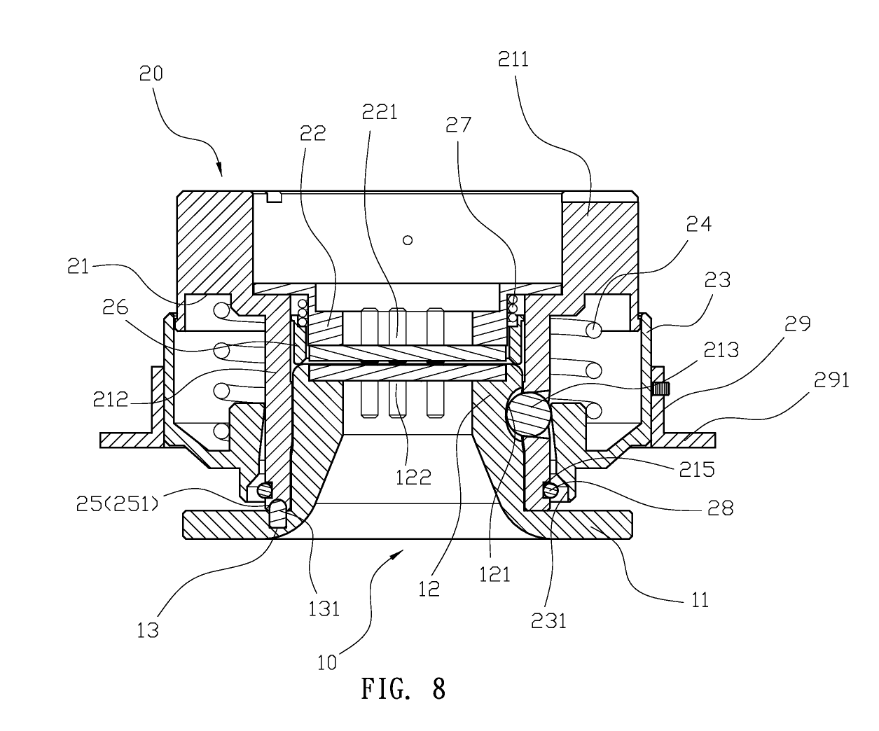

In another embodiment shown in FIG. 7, the fixed unit (10) has a first interval (13) at the bottom portion (11) and a trough (132) is formed at the first interval (13) of the fixed unit (10). The connecting unit (20) forms a second interval (25) at the end of the conjugating portion (212) and a protruding piece (252) is formed at the second interval (25). When the rolling balls (213) of the connecting unit (20) does not align with the ball slot (121) of the fixed unit (10), the connecting unit (20) cannot move close toward the fixed unit (10), so that the movable connecting points (221) of the connecting unit (20) and the fixed connecting points (122) of the fixed unit (10) have an appropriate space in between to avoid a short circuit due to incorrect connection. When the rolling balls (213) align with the ball slots (121), the protruding piece (252) can be inserted into the trough (132) to further cause the connecting unit (20) and the fixed unit (10) to contact with each other, so that the movable connecting points (221) and the fixed connecting points (122) form a contact status as well. Referring to FIG. 8, the connecting unit (20) has an auxiliary cover (29) outside the control cover (23), and the auxiliary cover (29) has an extended wing portion (291) to provide a large surface area for the user to hold to further facilitate the assembling and disassembling process of the connecting unit (20).

According to the structure in the abovementioned embodiments, the present invention is advantageous that (a) the fixed unit (10) has a plurality of ball slots (121) while the connecting unit (20) has a plurality of rolling balls (213), and the rolling balls (213) and the ball slots (121) form a structure to quickly assemble and disassemble the fixed unit (10) and the connecting unit (20). The fixed unit (10) has a first interval (13) at the bottom portion (11), and the second interval (25) is formed at the conjugating portion (212) of the connecting unit (20). When the rolling balls (213) does not align with the ball slot (121), the movable connecting points (221) and the fixed connecting points (122) has an appropriate space using the first interval (13) and second interval (25) to avoid a short circuit due to incorrect connection and to assure the safety when assembling and disassembling the steering wheel; and (b) the connecting unit (20) has an auxiliary cover (29) outside the control cover (23), and the auxiliary cover (29) has an extended wing portion (291) to provide a large surface area for the user to hold to further facilitate the assembling and disassembling process of the connecting unit (20).

Having described the invention by the description and illustrations above, it should be understood that these are exemplary of the invention and are not to be considered as limiting. Accordingly, the invention is not to be considered as limited by the foregoing description, but includes any equivalent.

1. A steering wheel comprising:
a fixed unit, having a bottom portion and a connecting portion, wherein the bottom portion of the fixed unit is used to connect a steering wheel stick of a vehicle, and a first interval is formed at the bottom portion, wherein a plurality of ball slots are formed outside the connecting portion, and a plurality of fixed connecting points are formed at a terminal end of the connecting portion; and
a connecting unit, having a top portion and a conjugating portion, wherein the top portion of the connecting unit is used to connect a steering wheel of the vehicle, and the conjugating portion has a plurality of rolling balls and movable connecting points, and a second interval is formed at a terminal end of the conjugating portion, wherein the connecting unit covers the connecting portion of the fixed unit through the conjugating portion, and the rolling balls and ball slots are used to form a structure for quickly assembling and disassembling the steering wheel, and when the rolling balls are not aligned with the ball slots, the fixed connecting points and movable connecting points have a space in between due to misalignment of the first interval and second interval.

2. The steering wheel of claim 1, wherein a protruding block is formed at the first interval, and a recessed slot is formed at the second interval to receive the protruding block so that the connecting unit and the fixed unit can stay contact with each other, as well as the fixed connecting points and the movable connecting points.

3. The steering wheel of claim 1, wherein a trough is formed at the first interval, and a protruding piece is formed at the second interval, and the protruding piece can be inserted into the trough to make the fixed unit and connecting unit stay in contact with each other, as well as the fixed connecting points and the movable connecting points.

4. The steering wheel of claim 1, wherein the connecting unit has a main connecting body, a connecting plate, a control cover and a spring; the top portion and the conjugating portion formed at the main connecting body, the movable connecting points formed at the connecting plate, and the connecting plate secured in the main connecting body with one or more screws.

5. The steering wheel of claim 1, wherein a through hole is formed inside the main connecting body through the top portion and conjugating portion, and the connecting plate is located in the through hole, wherein a ring and a resilient unit are formed between the connecting plate and main connecting body, so that the ring pushes the rolling ball of the conjugating portion under a normal situation with the force provided by the resilient unit.

6. The steering wheel of claim 1, wherein the control cover covers the conjugating portion of the connecting unit and recessedly forms an escaping ring slot towards the conjugating portion to provide a space for the rolling balls, wherein the spring is disposed between the control cover and main connecting body, and when the control cover moves to compresses the spring relatively to the main connecting body, the rolling balls roll into the escaping ring slot of the control cover.

7. The steering wheel of claim 1, wherein a ring slot is formed at the conjugating portion of the connecting unit and the ring slot has a C-shaped hook to stop the control cover, so that the control cover and the spring is not allowed to escape from the main connecting body.

8. The steering wheel of claim 1, wherein an auxiliary cover is located outside the control cover of the connecting unit and the auxiliary cover has a wing portion to provide a surface area for a user to hold to facilitate assembling and disassembling process of the connecting unit.

9. The steering wheel of claim 1, wherein each fixed connecting point of the fixed unit and each movable connecting point of the connecting unit include an anode connecting point and a cathode connecting point, and the cathode connecting point can be connected with a plurality of anode connecting point.
